(19) United States
(12) Patent Application Publication
(10) Pub. No.: US 2017/0300885 A1
(43) Pub. Date: Oct. 19, 2017

(54) SYSTEM AND METHOD FOR REAL TIME MONITORING AND BUDGETING FOR UTILITIES CONSUMPTION

(71) Applicant: Johann Christian Niehaus, Austin, TX (US)

(72) Inventor: Johann Christian Niehaus, Austin, TX (US)

(21) Appl. No.: 15/133,178

(22) Filed: Apr. 19, 2016

(51) Int. Cl. G06Q 20/14; G06Q 50/06

(52) U.S. Cl. CPC G06Q 20/145; G06Q 50/06

(57) ABSTRACT

A system and method is disclosed providing utility customers with real-time utility usage and costs within the billing cycle. Utility customers are presented with real-time data that helps them budget during a billing cycle so they are not surprised by utility costs come billing time. The system includes a utility sensor coupled to a utility line. Data from the sensor is provided to a conversion module which transmits the converted signal to a control module for processing. The control module uses the usage measurement from the utility sensor to monitor consumption rates and calculate usage costs as well as projected costs.

### CROSS-REFERENCE TO RELATED APPLICATIONS

None.

### BACKGROUND

The embodiments herein relate generally to monitoring systems, and more particularly, to a system and method for real time monitoring and budgeting for utilities consumption.

Utilities' supplies are increasingly being stressed worldwide. For example, many areas suffer from common electrical brown or blackouts because the demand for electricity is greater than the capabilities of the grid. Some areas experience drought conditions resulting in water conservation measures including for example water rationing. A common approach is to discourage utility use by raising rates with raised consumption. Consumption is usually monitored by meters installed in the customer's location. As a result, utilities' delivery cost in municipal and other areas where consumption is metered are becoming more expensive. Typically usage and billing is not shown until the end of a billing cycle. This can have a negative impact on budgets since a utility customer does not know during the metering month how much his/her utilities bill will be, often resulting in sticker shock at the end of the month.

As can be seen, there is a need for a system and method to provide utility customers real-time usage information to better budget consumption and expense on a monthly basis.

### SUMMARY

According to one embodiment of the present invention, system of monitoring utility resource usage at a customer usage site comprises a utility sensor positioned in a measurement point of utility consumption; a measurement conversion module electrically coupled to the utility sensor, the measurement conversion module configured to provide a signal representing a usage measurement; a control module electrically coupled to the measurement conversion module; and an electronic display physically connected to the control module at the customer usage site or a mobile computing device wirelessly connected to the control module, wherein the control module is adapted to receive the signal representing a usage measurement and provide the usage measurement and a cost associated with the usage measurement to the local electronic display or the mobile computing device, the usage measurement and cost displayed in real-time to a customer.

According to another embodiment of the present invention, a method of providing real-time utility consumption to a utility customer comprises receiving on an electronic display of a computer user interface, an input representing a utility charge rate per utility unit; measuring via a customer installed utility sensor in a utility line, a current usage measurement for a billing cycle; receiving the measured current usage measurement at the computer user interface; calculating via a processing unit configured to transmit data to the computer user interface, a real-time cost associated with the measured current usage measurement; and displaying on the electronic display and computer user interface, the calculated real-time cost.

### BRIEF DESCRIPTION OF THE FIGURES

The detailed description of some embodiments of the present invention is made below with reference to the accompanying figures, wherein like numerals represent corresponding parts of the figures.

FIG. 1 is a flowchart for a method of providing real-time utility consumption to a utility customer in use in accordance with an exemplary embodiment of the subject technology.

FIG. 2 is a block diagram of a system of monitoring utility resource usage at a customer usage site in accordance with an exemplary embodiment of the subject technology.

### DETAILED DESCRIPTION OF CERTAIN EMBODIMENTS

The word “exemplary” is used herein to mean “serving as an example or illustration.” Any aspect or design described herein as “exemplary” is not necessarily to be construed as preferred or advantageous over other aspects or designs.

In general, exemplary embodiments of the present invention provide utility customers with real-time utility usage and costs within the billing cycle. As will be appreciated, aspects of the present invention help utility customers budget during a billing cycle so they are not presented with sticker shock at the end of billing. Moreover, if there is a utility leak, customers will be able to identify unusual or excessive use and be alerted to the potential leak in the utility line. As will be further appreciated, this may help conserve utility resources and avoid potential dangerous situations or damage from leaking utility lines.

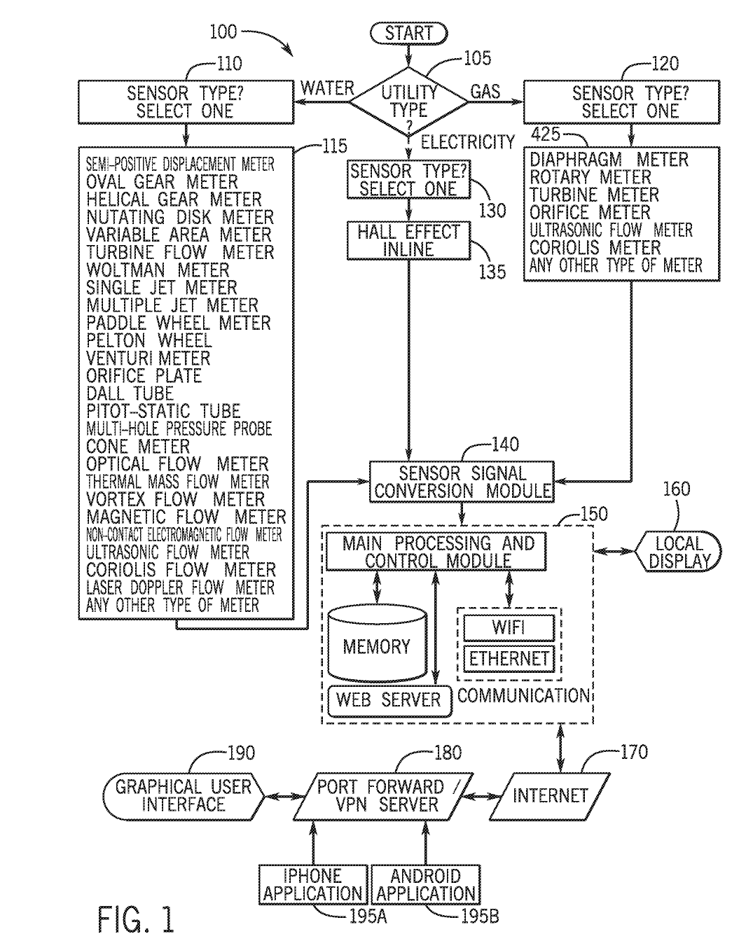

Referring to FIG. 1, a method 100 of providing real-time utility consumption to a utility customer is shown according to an exemplary embodiment. The method 100 may be implemented by, for example a processing unit executing programming instructions in a software application. As will be described below, the software application may be resident on the processing unit or be presented for user interaction on a computing device. As such, the steps that follow will be understood to be performed by the processing unit unless otherwise indicated. In block 105, a utility type being monitored may be determined. For example, does the user want information related to water, natural gas, or electricity consumption? In block 110, for water consumption, a type of water flow sensor is selected from one of various types of sensors shown in block 115. Similar actions are performed in blocks 120 and 125 for natural gas usage detection and in blocks 130 and 135 for electricity usage detection. Depending on the sensor type, a sensor signal conversion module may convert sensor data into consumed units of a utility resource. In block 150, a main processing and control module may retrieve from memory a stored list of sensor type files and the conversion metrics necessary for converting the signal into a usage measurement. In addition, a user may input into stored memory the current cost rate per consumed utility resource unit. The processing unit may then calculate in real-time the cost associated with the usage measurement at any given time. Information and interaction with the main processing and control module may occur either directly via an electronic display 160 or by wired communication via Ethernet ports or wirelessly via Wi-Fi. Some data may be stored remotely in a web based server. Access to the data received and calculated by the main processing and control module may be accessed via Internet in block 170. The data may be provided by a port forward/VPN server 180 accessed by a software application usable through a graphical user interface 190 or mobile devices 195A or 195B implementing iPhone or Android operating systems.

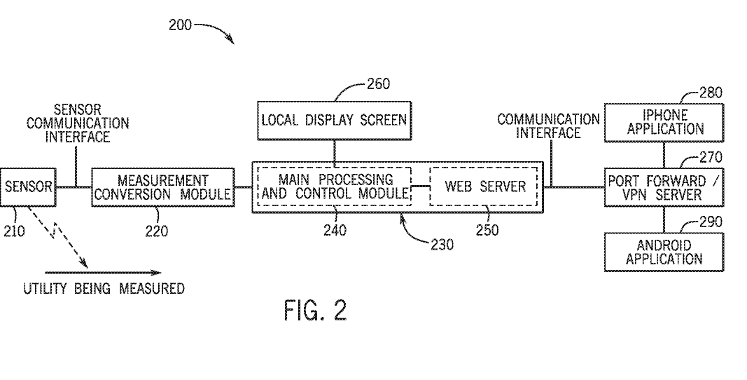

Referring now to FIG. 2, a system 200 of monitoring utility resource usage at a customer usage site is shown according to an exemplary embodiment. A utility sensor 210 (for example any of the sensors shown in FIG. 1) may be retrofit onto an existing utility line whose flow is being measured by the utility customer. The sensor will be installed either in-line with the utility supply or simply clamped to the utility pipe or wire. A measurement conversion module 220 may be coupled to the utility sensor. In some embodiments, there may be a sensor communication interface between the utility sensor 210 and the measurement conversion module 220. The measurement conversion module 220 may be connected to a control module 230. The control module 230 may include a main processing unit and connection to a web server 250. In some embodiments, the control module 230 is on site (electrically connected to the measurement conversion module 220) at the utility customer's residence or facility. In some embodiments, the control module 230 may be wirelessly connected to the measurement conversion module 220 and is either onsite or offsite. For onsite embodiments, a local electronic display screen 260 may be physically connected or wirelessly to the control module 230 allowing the user to access data provided by the control module 230. The user may also be able to input data into the control module 230 (for example, current rates of charge per unit of consumption) through the display 260. Some embodiments may provide a software application that may access the control module 230 wirelessly through mobile device platforms 280 and 290 through a port forward/VPN server 270. The mobile device platforms 280 and 290 may be accessed by a mobile computing device (for example, a smart phone, computing tablet, wearable computing device, or a general computing device) with a display and computer processor.

As will be understood, while the foregoing was described primarily in the context of a single utility being measured at a time, embodiments may include sensors and monitoring for each utility at a location. The software application may thus present to the user data related to each utility being monitored.

The following are some features that may be accessed through the software application. A main screen may display a chart of utility consumption for the current billing cycle real-time total cost of utilities consumed, how many days of consumption is left before reaching a customer set budget. Also a projected consumption and cost if consumption continues at a current rate or same rate as a last 24-hours, or the same rate as the current monthly average. Also shown will be the money left in the budget. A history screen may display the utility consumption for the current month as a default setting. In addition the consumer can also select options to view charts for consumption over the past week, past month, past year, or this month versus the last month, or this month versus the same month last year. A setup screen may allow the consumer to set the system up for their own situation. Inputs will be a selection of water/gas pi and diameter, or current transformer rating for electricity measurement. Also available will be an input to enter utilities cost per measurement unit, or an option to just enter information off a last utilities bill. As described above, the system will calculate costs. Additional inputs may include the billing period length for each utility being monitored, local Wi-Fi SSID and passwords, option to clear the local database, reset system to factory conditions, consumer monthly budget for each utility being monitored, and e-mail address contact information. The consumer may receive a monthly report of utility usage via e-mail. The consumer can also enable/disable network connectivity.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A system of monitoring utility resource usage at a customer usage site, comprising:
a utility sensor positioned in a measurement point of utility consumption;
a measurement conversion module coupled to the utility sensor, the measurement conversion module configured to provide a signal representing a usage measurement;
a control module coupled to the measurement conversion module; and
an electronic display connected to the control module at the customer usage site or a mobile computing device wirelessly connected to the control module, wherein
the control module is adapted to receive the signal representing a usage measurement and provide the usage measurement and a cost associated with the usage measurement to the local electronic display or the mobile computing device, the usage measurement and cost displayed in real-time to a customer.

2. The system of claim 1, wherein the utility sensor is adapted to measure natural gas flow.

3. The system of claim 1, wherein the utility sensor is adapted to measure water flow.

4. The system of claim 1, wherein the sensor conversion module is retrofit onto an existing utility line and distinct from a utility provider sensor conversion module.

5. The system of claim 1, further comprising a processing unit in the control module programmed to read the signal representing a usage measurement and calculate the cost based on a price rate of consumption and an amount of utility resource usage consumed during a billing cycle.

6. The system of claim 1, further comprising a software application accessible through the mobile computing device, the software application configured to display upon user request, a current measured utility usage at the utility sensor and the cost associated with the usage measurement.

7. A method of providing real-time utility consumption to a utility customer, comprising:
receiving on an electronic display of a computer user interface, an input representing a utility charge rate per utility unit;
measuring via a customer installed utility sensor in a utility line, a current usage measurement for a billing cycle;
receiving the measured current usage measurement at the computer user interface;
calculating via a processing unit configured to transmit data to the computer user interface, a real-time cost associated with the measured current usage measurement; and
displaying on the electronic display and computer user interface, the calculated real-time cost.
